(19) United States
(12) Patent Application Publication
(10) Pub. No.: US 2018/0340421 A1
(43) Pub. Date: Nov. 29, 2018

(54) TOOL AND METHOD FOR REMOVAL OF A PORTION OF AN AIRCRAFT COMPONENT

(71) Applicant: Bell Helicopter Textron Inc., Fort Worth, TX (US)

(72) Inventors: Alison A. Woodruff, North Richland Hills, TX (US); Norman C. Jordan, Springtown, TX (US)

(73) Assignee: Bell Helicopter Textron Inc., Fort Worth, TX (US)

(21) Appl. No.: 15/605,813

(22) Filed: May 25, 2017

(51) Int. Cl. F01D 5/00; H05B 3/56; B64F 5/40; B32B 43/00

(52) U.S. Cl. CPC F01D 5/005; H05B 3/56; F01D 5/286; B32B 43/006; B64F 5/40

(57) ABSTRACT

A tool for removing a portion of a rotor blade including a bracket; a mounting member slidably coupled to the bracket; and a heating element coupled to the mounting member, the heating element configured to heat and slide underneath a portion of a rotor blade to be removed. An embodiment provides a method for removing a portion of a rotor blade positioning a tool adjacent to a rotor blade with a portion of the rotor blade to be removed, heating at least some of the portion of the rotor blade to be removed with the heating element; slidably moving the mounting member such that the heating element moves between the rotor blade and the portion of the rotor blade to be removed; and disengaging a portion of the rotor blade to be removed from the rotor blade.

### BACKGROUND

### Technical Field

The present disclosure relates to tools and methods for disengagement and removal of a portion of a rotor blade, e.g., an abrasion strip and erosion shield, or other aircraft component.

### Description of Related Art

Removal of abrasion strips and erosion shields from an aircraft rotor blade is traditionally accomplished manually with a hammer and a wedge. Such removal is often inaccurate, inefficient, and noisy and can result in operator fatigue and, therefore, operator error and injury. Improper or inaccurate hammer strikes can lead to delamination of rotor blade components (e.g., such as spar plies) or to skin to core voids, both of which can be costly or impossible to repair.

There is a need for a tool and method for disengagement and/or removal of one component from another component, such as disengagement and/or removal of a rotor blade and an abrasion strip or an erosion shield, in a safe, effective, and efficient manner that decreases operator error, decreases cost of repair, and increases the life of the rotor blade.

### SUMMARY

In a first aspect, there is a tool for removing a portion of a rotor blade including a bracket; a mounting member configured to be slidably coupled to the bracket; and a heating element configured to be coupled to the mounting member, the heating element configured to heat and slide underneath a portion of a rotor blade to be removed.

In an embodiment, the heating element is configured to be coupled to the mounting member such that, when the heating element contacts a portion of a rotor blade, at least some of the heating element substantially conforms to the portion of the rotor blade.

In another embodiment, the heating element is configured to be heated to at least 180 degrees Fahrenheit by an electric current.

In yet another embodiment, the portion of the rotor blade to be removed includes an abrasion strip, and the heating element is configured to be heated to a temperature that is less than a melting point of a blade skin resin.

In still another embodiment, the portion of the rotor blade to be removed includes an abrasion strip configured to be coupled to the rotor blade by an adhesive, and the heating element is configured to be heated to a temperature that is approximately equal to a melting point of the adhesive.

In one embodiment, the mounting member includes a first arm and a second arm, the first and second arms are fixedly connected at one end and the heating element is coupled to the opposing ends of the first and second arms.

Another aspect provides a tool for removing a portion of a rotor blade including a bracket configured to be positioned adjacent to a rotor blade; a mounting member slidably coupled to the bracket; and a heating element coupled to the mounting member, the heating element configured to heat and slide underneath a portion of the rotor blade to be removed; wherein the mounting member slides on the bracket such that the heating element disengages a portion of the rotor blade to be removed from the rotor blade.

In an embodiment, the bracket includes a plurality of bars that are positioned about parallel to the leading edge of the rotor blade.

In another embodiment, the mounting member includes a first arm coupled to a second arm at an angle, the first arm and the second arm each including an opening for receiving a bar therethrough.

In yet another embodiment, the heating element is coupled at one end to the first arm and the opposing end to the second arm such that at least some of the heating element conforms to the portion of the rotor blade to be removed.

In still another embodiment, the mounting member is generally curvilinear in shape.

In one embodiment, at least one of the heating element, the mounting member, and the bracket are configured to bias the heating element toward the portion of the rotor blade to be removed.

In another embodiment, the tool includes a biasing element associated with the heating element and at least one of the first arm and the second arm, the biasing element configured to bias the heating element toward the portion of the rotor blade to be removed.

Still another aspect provides a method for removing a portion of a rotor blade including positioning a tool adjacent to a rotor blade with a portion of the rotor blade to be removed, where the tool includes: a bracket; a mounting member slidably coupled to the bracket; and a heating element coupled to the mounting member; heating at least some of the portion of the rotor blade to be removed with the heating element; slidably moving the mounting member such that the heating element moves between the rotor blade and the portion of the rotor blade to be removed; and disengaging a portion of the rotor blade to be removed from the rotor blade.

In an embodiment, the step of positioning further includes positioning the heating element in a recess adjacent to the portion of the rotor blade to be removed.

In another embodiment, the method includes coupling the heating element to the mounting member in a tension configuration.

In yet another embodiment, the heating element is an electrically conductive wire.

In still another embodiment, the portion of the rotor blade to be removed includes an abrasion strip.

In one embodiment, the heating step includes heating an adhesive that secures the abrasion strip to the rotor blade to a temperature that melts a portion of the adhesive.

In another embodiment, the heating step includes passing an electric current through the heating element.

In still another embodiment, the slidably moving step includes moving the mounting member substantially parallel to the leading edge of the rotor blade.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF THE DRAWINGS

The novel features believed characteristic of the embodiments of the present disclosure are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a perspective view of an aircraft, according to one example embodiment;

FIG. 2 is another perspective view of an aircraft, according to one example embodiment;

FIG. 3 is a perspective view of another aircraft, according to one example embodiment;

FIG. 4 is perspective view of a rotor blade;

FIG. 5 is a top view of a tool, according to one example embodiment;

FIG. 6 is a cross-sectional view of a tool, according to one example embodiment;

FIG. 7 is a cross-sectional view of a tool, according to one example embodiment;

FIG. 8 is a cross-sectional view of another tool, according to one example embodiment; and

FIG. 9 is a top view of a tool, according to one example embodiment.

### DESCRIPTION OF THE PREFERRED EMBODIMENT

Illustrative embodiments of the tools and methods are described below. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, assemblies, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the devices, members, assemblies, etc. described herein may be oriented in any desired direction. The terms “disengage” and “remove” and derivatives thereof are used synonymously herein and should be understood broadly to include any loosening, separating, detaching, releasing, freeing, disconnecting, uncoupling, and/or undoing, whether partially or wholly, of one component from another component.

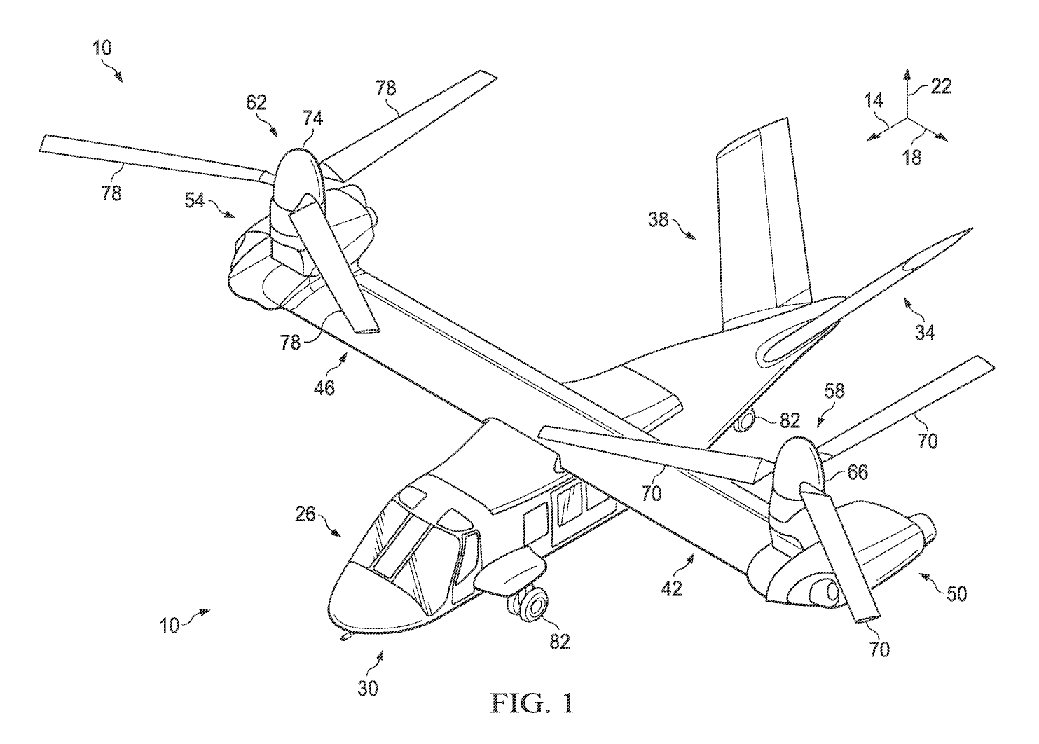

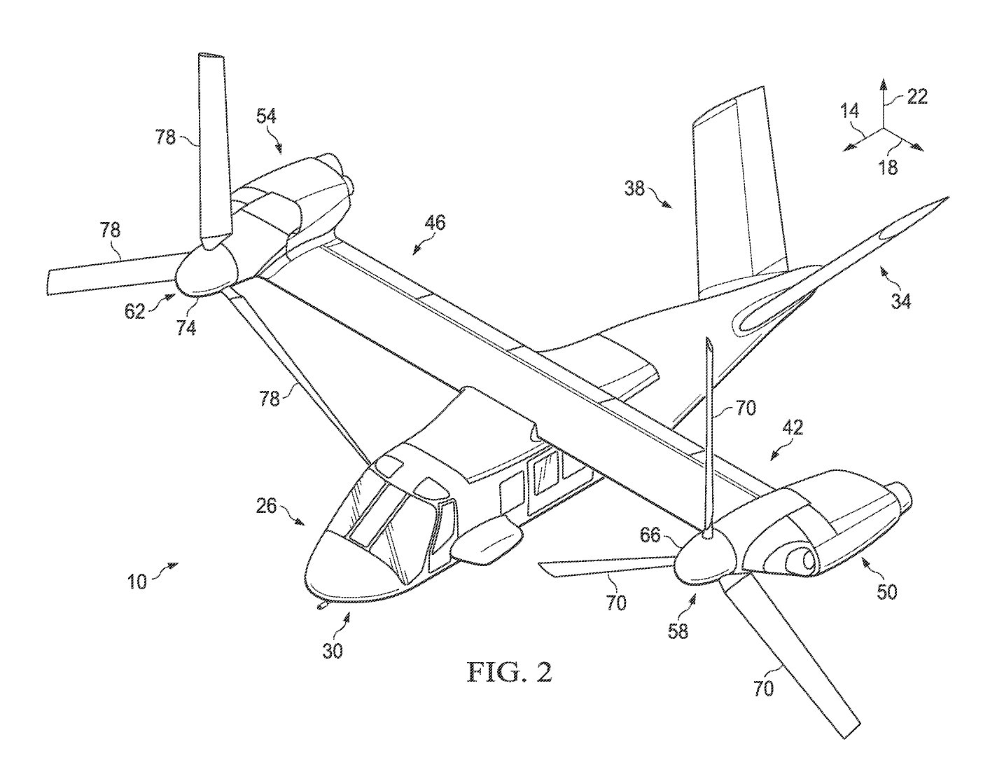

FIGS. 1-2 depict aircraft 10 and three mutually orthogonal directions X, Y, and Z forming a three-dimensional frame of reference XYZ. Longitudinal axis X 14 corresponds to the roll axis that extends through the center of aircraft 10 in the fore and aft directions. Transverse axis Y 18 is perpendicular to longitudinal axis 14 and corresponds to the pitch axis (also known as a control pitch axis or “CPA”). The X-Y plane is considered to be “horizontal.” Vertical axis Z 22 is the yaw axis and is oriented perpendicularly with respect to the X-Y plane. The X-Z plane and Y-Z plane are considered to be “vertical.”

Aircraft 10 includes fuselage 26 as a central main body. Fuselage 26 extends parallel to longitudinal axis 14 from a fuselage front end 30 to a fuselage rear end 34. Aircraft 10 further includes tail member 38 extending from fuselage rear end 34 of fuselage 26. Aircraft 10 includes wing 42 and wing 46 extending from fuselage 26 substantially parallel to transverse axis Y 18. Wing 42 is coupled to propulsion system 50, and wing 46 is coupled to propulsion system 54. Propulsion system 50 includes rotor assembly 58, and propulsion system 54 includes rotor assembly 62. Rotor assembly 58 includes rotor hub 66 and plurality of rotor blades 70 extending from rotor hub 66. Similarly, rotor assembly 62 includes rotor hub 74 and plurality of rotor blades 78 extending from rotor hub 74. Aircraft 10 can, for example, be coupled to and controlled with a power system connected to a drive system, such as one continuous drive system or a segmented drive system separated by a gearbox, including electric propulsion systems, hydraulic drive systems, or a conventional drive system.

Rotor assemblies 58 and 62 are controllable and positionable to, for example, enable control of direction, thrust, and lift of aircraft 10. For example, FIG. 1 illustrates aircraft 10 in a first configuration, in which propulsion systems 50 and 54 are positioned to provide a lifting thrust to aircraft 10, if activated. In the embodiment shown in FIG. 1, propulsion systems 50 and 54 are positioned such that, if activated, aircraft 10 moves substantially in the Z direction (“helicopter mode”). In the embodiment shown in FIG. 1, aircraft 10 further includes landing gear 82 with which aircraft 10 can contact a landing surface.

FIG. 2 illustrates aircraft 10 in a second configuration, in which propulsion systems 50 and 54 are positioned to provide a forward thrust to aircraft 10, if activated. In the embodiment shown in FIG. 2, propulsion systems 50 and 54 are positioned such that, if activated, aircraft 10 moves substantially in the X direction (“airplane mode”). In the second configuration depicted in FIG. 2, wings 42 and 46 enable a lifting thrust to be provided to aircraft 10. Wings 42 and 46 can be configured to increase the wing span and wing aspect ratio, which thereby increases lift/draft ratio, aircraft efficiency, and fuel economy. Though not depicted in FIGS. 1-2, propulsion systems 50 and 54 can be controllably positioned in helicopter mode, airplane mode, or any position between helicopter mode and airplane mode to provide for a desired direction, thrust, and/or lift.

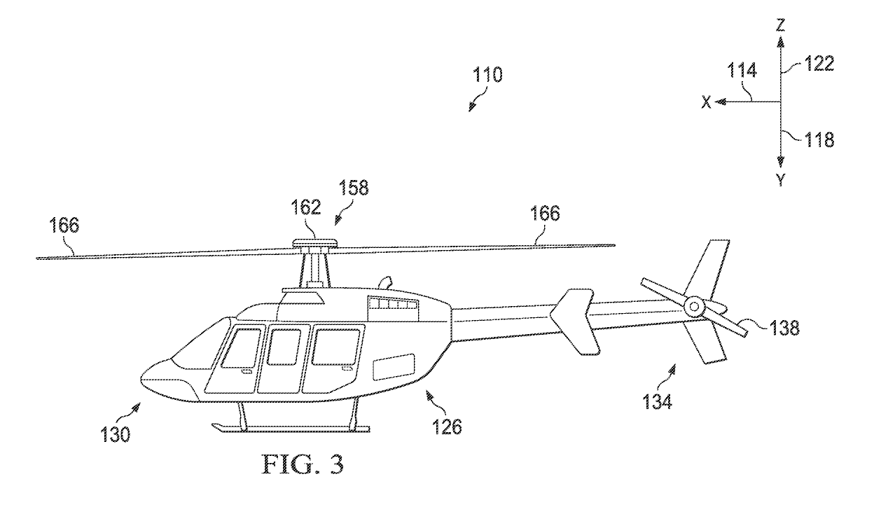

FIG. 3 depicts aircraft 110 and three mutually orthogonal directions X, Y, and Z forming a three-dimensional frame of reference XYZ. Longitudinal axis X 114 extends through the center of aircraft 110 in the fore and aft directions. Transverse axis Y 118 is perpendicular to longitudinal axis. The X-Y plane is considered to be “horizontal.” Vertical axis Z 122 is oriented perpendicularly with respect to the X-Y plane. The X-Z plane and Y-Z plane are considered to be “vertical.”

Aircraft 110 includes fuselage 126 as a central main body. Fuselage 126 extends parallel to longitudinal axis 114 from a fuselage front end 130 to a fuselage rear end 134. Aircraft 110 further includes tail rotor 138 extending from rear end 134 of fuselage 126. Aircraft 110 further includes rotor assembly 158, including hub 162 and plurality of rotor blades 166. Aircraft 110 can, for example, be coupled to and controlled with a power system connected to a drive system, such as one continuous drive system or a segmented drive system separated by a gearbox, including electric propulsion systems, hydraulic drive systems, or a conventional drive systems, as discussed in detail below. Rotor assembly 158 is controllable and positionable to, for example, enable control of direction, thrust, and lift of aircraft 110. For example, rotor assembly 158 can, if activated, provide a lifting thrust to aircraft 110 during takeoff and landing to enable aircraft 110 to move substantially in the Z direction. Furthermore, rotor assembly 158 can, if activated, provide a forward thrust to aircraft 110 to enable aircraft 110 to move substantially in the X direction. Tail rotor 138 can, if activated, counteract torque created by activation of rotor assembly 158 to, for example, stabilize aircraft 110 and/or prevent aircraft 110 (and, more specifically, fuselage 126) from rotating in the direction of rotor assembly 158.

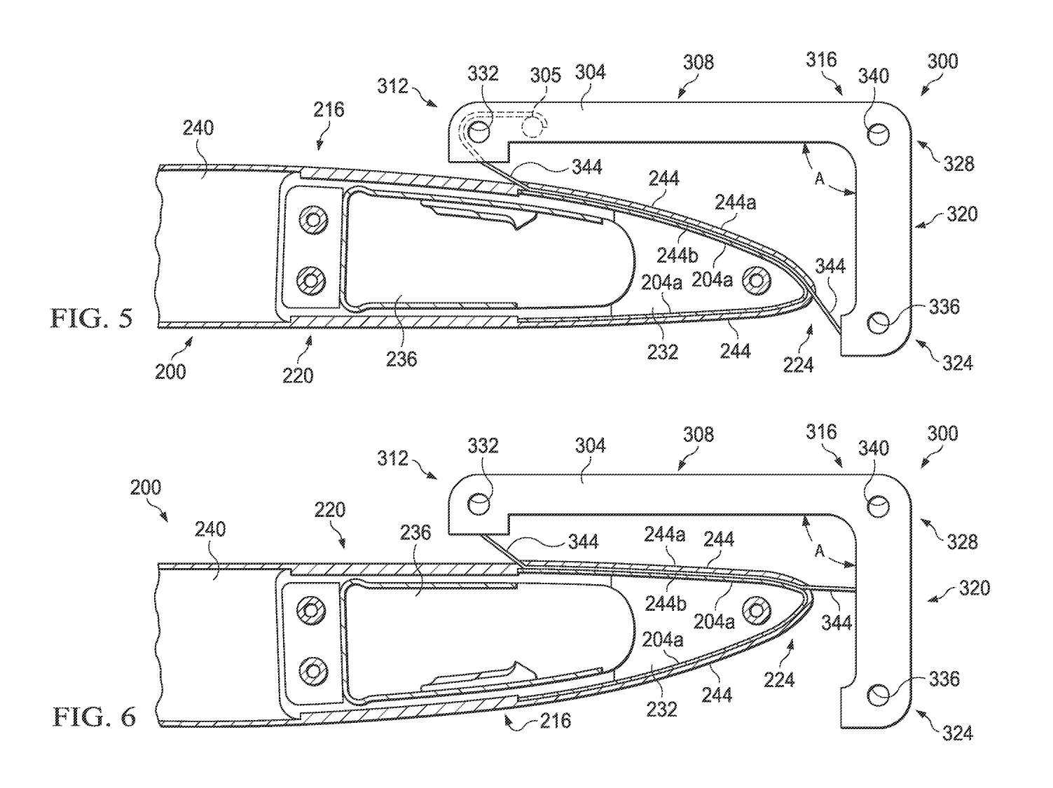

This disclosure depicts and describes tools, components and features thereof, and methods relating thereto. Any tool, component and feature thereof, or method relating thereto depicted in FIGS. 5-9 and/or described herein can be used with aircraft 10, aircraft 110, and rotor blade 200 depicted in FIGS. 1-4. Additionally, the tools, components and features thereof, and methods relating thereto depicted in FIGS. 5-9 and/or described herein can be used with any aircraft having one or more components to be disengaged or removed, such as abrasion strips, erosion shields, and the like, including tiltrotor aircrafts, helicopters, tilt wing aircrafts, unmanned aerial vehicles (UAVs), and other vertical lift or VTOL aircrafts, or can further be used with any device having one or more components to be disengaged or removed, including devices with rotors or propellers, windmills, and wind turbines. Further, any features of one embodiment of the tools or components thereof in this disclosure can be used with any other embodiment of the tools or components thereof in this disclosure such that the other embodiment has the same or similar features, operates in the same or similar way, or achieves the same or similar functions. Some components of this disclosure are depicted by graphic shapes and symbols. Unless this disclosure specifies otherwise, such components should be understood to include the same or similar characteristics and features as those components that are named or described, though the graphic shapes and symbols may not depict each such characteristic or feature.

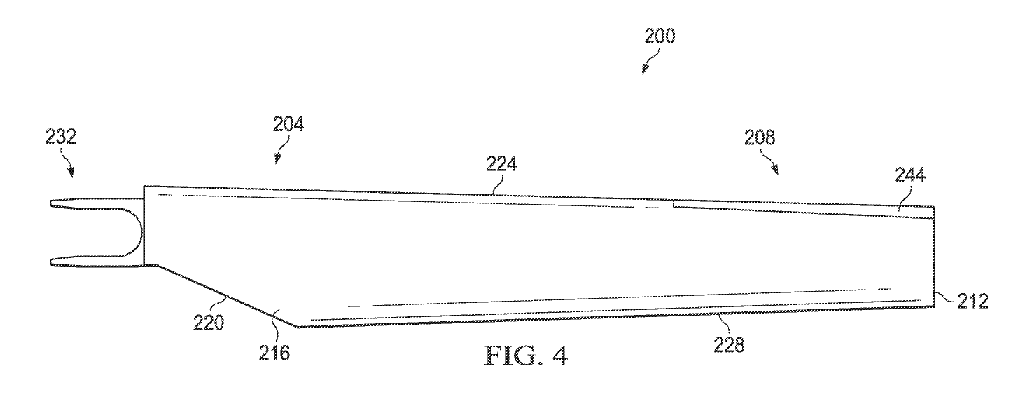

FIGS. 4-9 depict rotor blade 200. Rotor blade 200 has inboard portion 204 that is configured to be coupled to a hub and outboard portion 208 that ends in blade tip 212. Rotor blade 200 includes top surface 216, bottom surface 220, leading edge 224, and trailing edge 228, where top surface 216 and bottom surface 220 extend between leading edge 224 and trailing edge 228. Top surface 216 and bottom surface 220 can include blade skins made from carbon fiber composite, fiberglass, aluminum, titanium, and/or other composite structures. Rotor blade 200 further includes spar 232 extending at least partially within inboard portion 204 and outboard portion 208 and positioned between top surface 216, bottom surface 220, leading edge 224, and trailing edge 228. Rotor blade 200 further includes core material 236 and core material 240, which can be the same material or different material, and can include, for example, foam, air, honeycomb structures, and other composite structures and materials. Rotor blade 200 includes abrasion strip 244 coupled to the exterior surface 204a of the inboard portion 204 (e.g., top surface 216 and bottom surface 220 and extending from leading edge 224 toward trailing edge 228. In the embodiment shown, abrasion strip 244 extends from blade tip 212 toward inboard portion 204 of rotor blade 200. In other embodiments, abrasion strip 244 can extend further toward or further away from inboard portion 204 of rotor blade 200 and/or further toward trailing edge 228 depending, for example, on a given application, such as the extent to which particulate, precipitation, air pollutants, and the like, may come into contact with rotor blade 200. Abrasion strip 244 can be metal, such as titanium, nickel, stainless steel, and the like, or another hard material configured to provide protection to rotor blade 200, such as protection from particulate, precipitation, air pollutants, and other items that may come into contact with a rotor blade during rotation. For example, in some embodiments, abrasion strip 244 can be type 300 series 1/4 hard corrosion resistant stainless steel, which, for example, can be stretch formed to 1/2 hard condition. In an embodiment, abrasion strip 244 can further include an exterior surface 244a that is nickel-plated. Abrasion strip 244 can be coupled to top surface 216 and bottom surface 220 by, for example, an adhesive or epoxy base. One example of an adhesive that could be used to couple top surface 216 and bottom surface 220 is a thermosetting modified epoxy structural adhesive with a high bond strength, fracture toughness, and/or peel strength.

FIGS. 5-6 depict tool 300, which is configured to disengage and/or remove one component from another component, such as disengage and/or remove a portion of an aircraft from the remainder of the aircraft, including abrasion strips, erosion shields, and the like. More specifically, in the embodiment shown in FIGS. 5-6, tool 300 is configured to remove abrasion strip 244 from rotor blade 200. In the embodiment shown, tool 300 includes a mounting member 304. Mounting member 304 includes a first arm 308 having a first end 312 and a second end 316. Mounting member 304 further includes a second arm 320 having a first end 324 and a second end 328. First arm 308 (and, more specifically, second end 316 of first arm 308) is coupled to second arm 320 (and, more specifically, second end 328 of second arm 320) to define Angle A. In the embodiment shown, first arm 308 and second arm 320 are unitary (e.g., made of the same material and/or at the same time) such that Angle A is fixed; however, in other embodiments, first arm 308 and second arm 320 can be coupled to each other to enable adjustment of Angle A (e.g., by a hinge, a pivot, etc.) and, therefore, to enable adjustment of a distance between first end 312 of first arm 308 and first end 324 of second arm 320. For example, in the embodiment shown, Angle A is approximately 90 degrees. In other embodiments, Angle A can be, or can be adjusted to be, greater than 90 degrees (e.g., 95 degrees, 100 degrees, 105 degrees, 110 degrees) or an acute angle being less than 90 degrees (e.g., 85 degrees, 80 degrees, 75 degrees, 70 degrees) to, for example, enable tool 300 to be used to disengage and/or remove a variety of components.

In some embodiments, tool 300 can be manually moved with respect to the component to be removed. For example, a user can manually move tool 300 along a portion of an aircraft component, such as rotor blade 200, to remove a component of the aircraft component, such as abrasion strip 244. In other embodiments, a portion of tool 300 enables and/or facilitates movement of mounting member 304 with respect to the component to be removed. Such facilitation of movement by tool 300 can, for example, assist in stability of mounting member 304, enable automation of removal, and/or enable more precise removal techniques. In the embodiment shown in FIGS. 5-6, mounting member 304 is configured to be coupled to a portion of tool 300 that enables mounting member 304 to move with respect to the component to be removed. For example, in the embodiment shown in FIGS. 5-6, mounting member 304 includes opening 332 that extends through first end 312 of first arm 308, opening 336 that extends through first end 324 of second arm 320, and opening 340 that extends through a portion of first arm 308 and a portion of second arm 320 (e.g., opening 340 extends through mounting member 304 at a position at which first arm 308 and second arm 320 are coupled). Each of openings 332, 336, and 340 is configured to enable at least one bar to extend through each of openings 332, 336, and 340 such that, if at least one bar extends through each of openings 332, 336, and 340, mounting member 304 can move in a direction substantially parallel to each bar. In some embodiments, mounting member 304 can have more than three openings (e.g., four, five, six, seven, or more openings) or less than three openings (e.g., two, one, or zero openings), and, in such embodiments, the portion of tool 300 to which mounting member 304 is configurable to enable mounting member 304 to move with respect to the component to be removed. For example, tool 300 can be configured to enable mounting member 304 to slide, roll, or otherwise move with respect to the component to be removed. Slide means that the mounting member 304 is capable of moving over or along at least a portion of the component to be removed (e.g., the abrasion strip) and/or a bar (e.g., bars 510, 514, 518; or other alignment member configured to be received by the mounting member 304).

Tool 300 further includes heating element 344. Heating element 344 can include any component configured to be heated, such as an electrically conductive wire (e.g., a round wire, a flat wire, and the like). In the embodiment shown in FIG. 5, heating element 344 is coupled to first end 312 of first arm 308 and to first end 324 of second arm 320 in a first configuration. Tool 300 (and, more specifically, heating element 344) is configured to be positioned in contact with a portion of a rotor blade and, in the embodiment shown in FIG. 5, is depicted in contact with abrasion strip 244 and top surface 216 of rotor blade 200. As shown, at least some of heating element 344 is configured to conform generally to an interior surface 244b of the abrasion strip 244 and/or the top surface 216 of rotor blade 200. In the embodiment shown in FIG. 6, heating element 344 is coupled to first end 312 of first arm 308 and to second arm 320 at a position between first end 324 and second end 328 of second arm 320 in a second configuration. Tool 300 (and, more specifically, heating element 344) is configured to be positioned in contact with a portion of a rotor blade and, in the embodiment shown in FIG. 6, is depicted in contact with abrasion strip 244 and bottom surface 220 of rotor blade 200. As shown, at least some of heating element 344 is configured to conform to the interior surface of the abrasion strip 244 and/or the bottom surface 220 of rotor blade 200. In some embodiments, heating element 344 can be coupled to first arm 308 and second arm 320 in a single configuration that enables heating element 344 to be positioned in contact with a plurality of portions of a rotor blade (e.g., both top surface 216 and bottom surface 220 of rotor blade 200) such that at least some of heating element 344 substantially conforms to each portion of the rotor blade (e.g., rotor blade 200). In other embodiments, such as that shown in FIGS. 5-6, heating element 344 can be coupled at a plurality of positions along first arm 308 and second arm 320 (e.g., in the first configuration shown in FIG. 5 and in the second configuration shown in FIG. 6) to enable heating element 344 to be positioned in contact with a plurality of portions of a rotor blade (e.g., both top surface 216 and bottom surface 220 of rotor blade 200) such that at least some of heating element 344 substantially conforms to each portion of the rotor blade (e.g., rotor blade 200). The positions at which heating element 344 is coupled to mounting member 304, the length of heating element 344, the lengths of first arm 308 and/or second arm 320 of mounting member 304, and other features of tool 300 can be adjusted to enable heating element 344 to be positioned in contact with and to substantially conform to any given component.

Heating element 344 is configured to be heated. For example, at least one of mounting member 304 and heating element 344 is configured to be coupled to a power source (e.g., one or more batteries, generators, engines, and the like) that, if activated, heats heating element 344. For example, in some embodiments, the power source is configured to pass electric current (e.g., 12 Volts) through mounting member 304 and/or heating element 344 to heat heating element 344. The extent to which heating element 344 is configured to be heated can be adjusted based upon a given application. For example, in some embodiments, heating element 344 is configured to be heated to at least 150 degrees Fahrenheit (e.g., 150 degrees Fahrenheit, 160 degrees Fahrenheit, 170 degrees Fahrenheit, 180 degrees Fahrenheit, 190 degrees Fahrenheit, 200 degrees Fahrenheit, 210 degrees Fahrenheit, 220 degrees Fahrenheit, 230 degrees Fahrenheit, 240 degrees Fahrenheit, 250 degrees Fahrenheit, 260 degrees Fahrenheit, 270 degrees Fahrenheit, 280 degrees Fahrenheit, 290 degrees Fahrenheit, 300 degrees Fahrenheit, or more). In some embodiments, such as those in which tool 300 is being used to remove a portion of a rotor blade (e.g., abrasion strip 244 of rotor blade 200), heating element 344 is configured to be heated to a temperature that is less than a melting point of a component of the rotor blade (e.g., less than a melting point of a blade skin resin, less than a melting point of a blade skin, less than a melting point of a polymer cure, etc.) to, for example, ensure that such component of the rotor blade remains unaltered during removal of the portion of the rotor blade. In some embodiments, such as those in which tool 300 is being used to remove a portion of a rotor blade (e.g., abrasion strip 244 of rotor blade 200), heating element 344 is configured to be heated to a temperature that is equal to or greater than a melting point of an adhesive that couples one portion of the rotor blade to another portion of the rotor blade (e.g., such as the melting point of the adhesive or epoxy base that couples abrasion strip 244 to top surface 216 and bottom surface 220 of rotor blade 200) to, for example, ensure that the portion of the rotor blade that is to be removed is sufficiently disengaged.

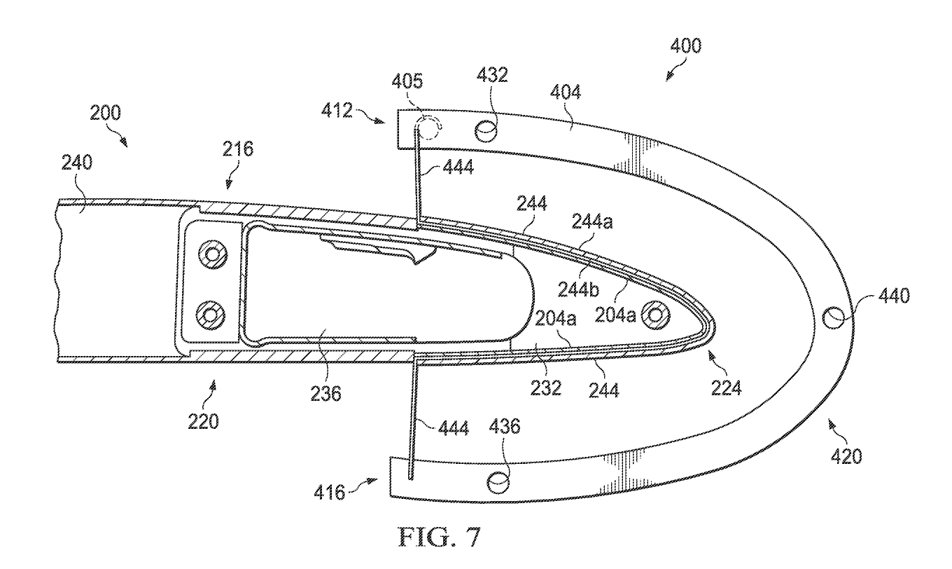

FIG. 7 depicts an alternative embodiment of tool 400, which is configured to disengage and/or remove one component from another component, such as disengage and/or remove a portion of an aircraft from the remainder of the aircraft, including abrasion strips, erosion shields, and the like. The tool 400 is substantially similar in form and function to the tool 300, except as noted herein. Thus, disclosure herein regarding tool 300 is also applicable to tool 400, except as noted herein. More specifically, in the embodiment shown in FIG. 7, tool 400 is configured to remove abrasion strip 244 from rotor blade 200. In the embodiment shown, tool 400 includes mounting member 404, which is a curvilinear member. Mounting member 404 has a first end 412, a second end 416, and a middle portion 420. In the embodiment shown, first end 412, second end 416, and middle portion 420 are unitary and define a curve that enables mounting member 404 to extend about a portion of a rotor blade (e.g., in the embodiment shown, mounting member 404 extends about top surface 216, leading edge 224, and bottom surface 220 of rotor blade 200); however, in other embodiments, first end 412, second end 416, and middle portion 420 can be coupled to each other to enable adjustment of mounting member 404 to extend about any given component.

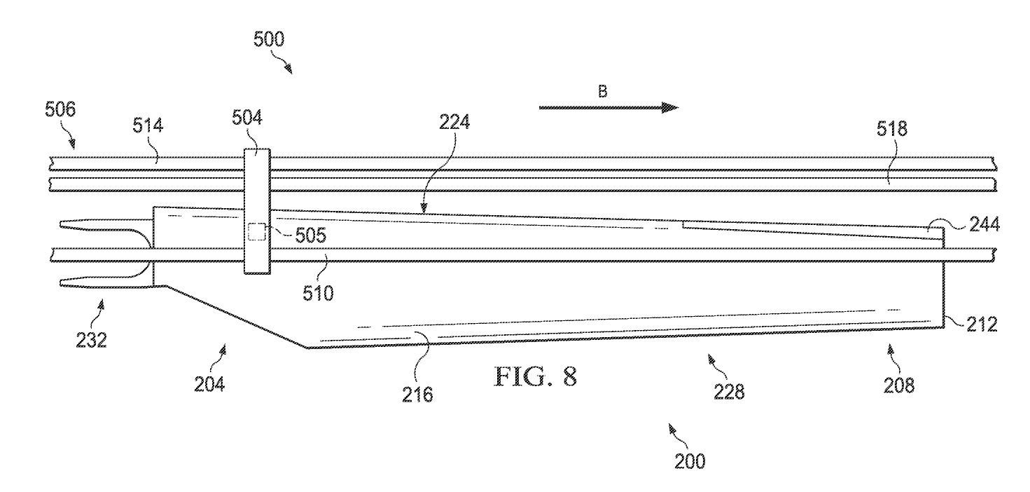

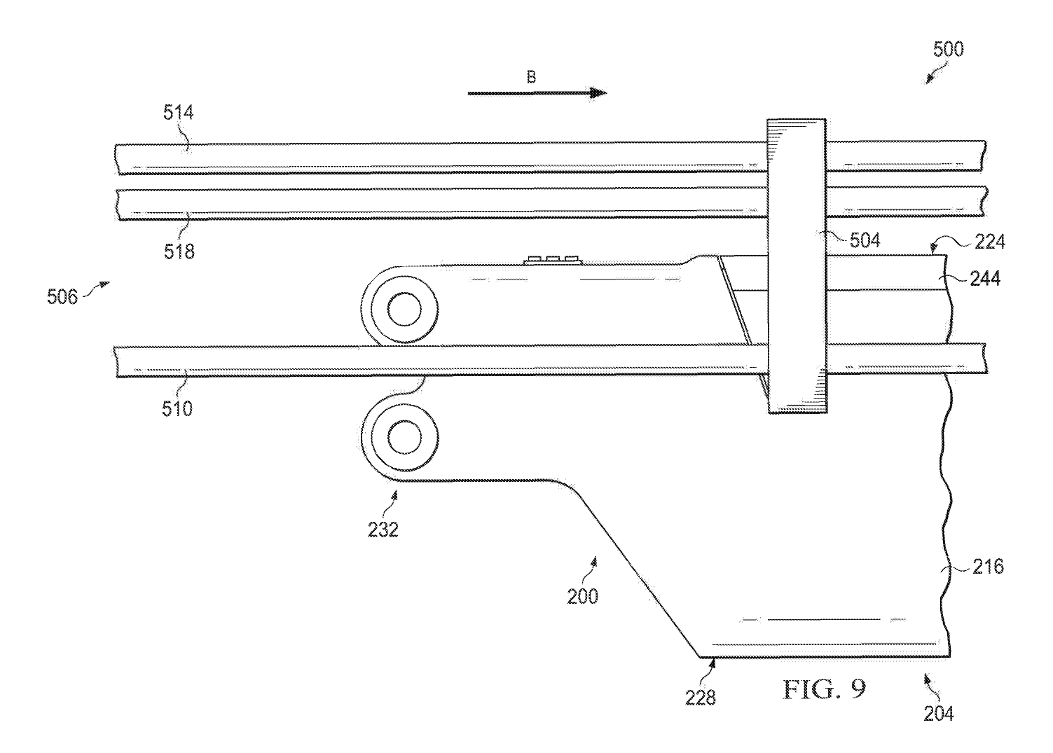

As discussed above, a tool of this disclosure can include a portion that enables movement of the disclosed mounting members with respect to the component to be removed. Such facilitation of movement by the disclosed tool can, for example, assist in stability of mounting members, enable automation of removal, and/or enable more precise removal techniques, among other things. For example, FIGS. 8-9 depict tool 500, which is configured to disengage and/or remove one component from another component, such as a portion of an aircraft from the remainder of an aircraft, including abrasion strips, erosion shields, and the like. More specifically, in the embodiment shown in FIGS. 8-9, tool 500 is configured to remove abrasion strip 244 from rotor blade 200. In the embodiment shown, tool 500 includes mounting member 504. Mounting member 504 is substantially similar in form and function to the mounting members 304, 404, except as noted herein. Thus, disclosure herein regarding mounting members 304, 404 is also applicable to mounting member 504, except as noted herein.

Mounting member 504 is configured to be coupled to bracket 506 (and is coupled to bracket 506, in the embodiment shown) to facilitate movement of mounting member 504. For example, bracket 506 enables mounting member 504 to move with respect to the component to be removed (e.g., with respect to abrasion strip 244 of rotor blade 200, in the embodiment shown). In the embodiment shown, bracket 506 includes bar 510, bar 514, and bar 518. In the embodiment shown, bar 510, bar 514, and bar 518 are each parallel to each other bar. Bracket 506 (and, more specifically, bars 510, 514, and 518) is configured to be positioned parallel to a rotor blade (and is depicted positioned parallel to rotor blade 200) to enable mounting member 504 to move in direction B, which is substantially parallel to bars 510, 514, and 518 and, therefore, substantially parallel to rotor blade 200. In one embodiment, the bracket 506 is configured such that mounting member 504 moves in a direction B parallel to the leading edge 224 of rotor blade 200. For example, similarly to mounting members 304 and 404, mounting member 504 can include openings that are each configured to enable one of bars 510, 514, and 518 to extend through the openings such that mounting member 504 can move in direction B substantially parallel to bars 510, 514, and 518. In some embodiments, bracket 506 can have more than three bars (e.g., four, five, six, seven, or more bars) or less than three bars (e.g., two, one, or zero bars), and, in such embodiments, bracket 506 is configured to enable mounting member 504 to move with respect to the component to be removed. For example, tool 500 (and, more specifically, bracket 506) can be configured in any way that enables mounting member 504 to slide, roll, or otherwise move with respect to rotor blade 200.

In some embodiments, a tool of this disclosure (e.g., tools 300, 400, and 500) is configured to bias the respective heating element to discourage movement of the heating element toward (or encourage movement of the heating element away from) an interior of a rotor blade (e.g., spar 232, core material 236, and/or core material 240 of rotor blade 200). In one embodiment, a tool can include a biasing element 305, 405, 505 to provide an upward and/or outward biasing force relative to the interior of the rotor blade 200. For example, the biasing element, such as a spring or a spring loaded wire spool, connected to the first arm and/or second arm can bias the heating element toward to the portion of the blade to be removed in a tension configuration. Such a bias can, for example, prevent damage to interior components of rotor blade 200. For example, if rotor blade 200 has a variable thickness such that rotor blade 200 increases in thickness from outboard portion 208 to inboard portion 204, the tool can be configured such that, if the mounting member is being moved from outboard portion 208 toward inboard portion 204, movement of the heating element toward an interior of rotor blade 200 is discouraged as rotor blade 200 increases in thickness. For example, in some embodiments, the tool can be configured to detect a change in thickness of a rotor blade (e.g., mechanically, such as through increased force on the mounting member or the heating element, and/or electrically, such as through one or more sensors) and adjust the heating element, the mounting member, and/or a bracket (if the mounting member is coupled to a bracket) to discourage movement of the heating element toward an interior of a rotor bade. In other embodiments, the tool is pre-adjusted to account for a change in thickness of a rotor blade. For example, in one embodiment, if a tool includes a bracket with one or more of bars, the one or more bars can be positioned non-parallel to one another such that, if the mounting member moves along the bars, the bars direct the heating element away from an interior of a rotor blade. In another embodiment, the mounting member and/or the heating element can be configured to tighten or loosen the heating element to discourage movement of the heating element toward an interior of a rotor blade.

In operation, a tool of this disclosure is used in methods for disengaging and/or removing one component from another component. Though one of the embodiments shown in FIGS. 5-9 may be used for reference in the described methods, any of tool 300, tool 400, tool 500 and combinations thereof may be used in the same or similar methods. Furthermore, though a rotor blade and/or an abrasion strip may be used for reference in the described methods, any two components can be disengaged using the same or similar methods.

For example, the methods include positioning a tool (and, more specifically, a heating element, such as heating element 344 or heating element 444) at least partially between two components, such as a rotor blade and a portion of the rotor blade to be removed (e.g., between top surface 216 or bottom surface 220 and abrasion strip 244). In some embodiments, the tool includes a mounting member (e.g., mounting member 304, mounting member 404, or mounting member 504) and a heating element (e.g., heating element 344 or heating element 444) configured to be heated and coupled to the mounting member. The tool is positioned such that the heating element is in contact with the portion of the component to be removed, such as in contact with an abrasion strip on a rotor blade (e.g., as depicted in FIGS. 5-7 and 9). In other embodiments, the tool can further include a bracket (e.g., bracket 506) configured, for example, to be positioned adjacent to (and, in the embodiment shown, parallel to) a component to be removed (e.g., rotor blade 200). In such an embodiment, the mounting member is configured to be coupled to the bracket to facilitate movement of the mounting member (e.g., in a direction parallel to the bracket and, therefore, in a direction parallel to the component to be removed). The method further includes heating the heating element (e.g., as described above with respect to FIGS. 5-9) and moving the mounting member (e.g., manually without a bracket, manually with a bracket to guide the mounting member, or automatically, such as by a machine) such that the heating element moves between the two components, such as between the rotor blade and the portion of the rotor blade to be removed. Such movement of the heated heating element encourages disengagement of one component from another component. In some embodiments, moving the mounting member includes moving the mounting member substantially parallel to the component to be removed, such as substantially parallel to an abrasion strip of a rotor blade. In some embodiments, moving the mounting member includes positioning the bracket substantially parallel to the rotor blade and sliding the mounting member with respect to the bracket such that the mounting member moves substantially parallel to the rotor blade.

The methods further include disengaging one component from another component, such as the rotor blade from the portion of the rotor blade to be removed. In the case of an abrasion strip coupled to a rotor blade by an adhesive, movement of the heated heating element, for example, encourages melting of the adhesive to disengage the abrasion strip from the rotor blade. The speed with which the tool is moved and the temperature of the heating element can be adjusted depending, for example, on the component to be removed, such as on the melting temperature of an adhesive that couples one component to another component, on the melting temperature of surrounding components to be protected from damage, and the like. For example, in some embodiments, heating the heating element includes heating the heating element to equal to or greater than the melting temperature of an adhesive coupling one component to another component, such as an abrasion strip to a rotor blade. As another example, in some embodiments, heating the heating element includes heating the heating element to less than the melting temperature of a component to be protected from damage, such as a blade skin, a blade skin resin, and/or other surrounding components.

In some embodiments, when the two components to be disengaged are a rotor blade and an abrasion strip, the methods further include separating the abrasion strip into a first portion and a second portion (e.g., as depicted in FIGS. 5-6), such as by grinding the abrasion strip (e.g., at or near leading edge 224), cutting the abrasion strip, hammering the abrasion strip, melting the abrasion strip, and/or similar separation methods. The methods further include positioning the heating element at least partially between the rotor blade and the first portion of the abrasion strip (e.g., such as between the top surface 216 and abrasion strip 244, as depicted in FIG. 5), moving the mounting member such that the heating element moves between the rotor blade and the first portion of the abrasion strip, and disengaging the rotor blade from the first portion of the abrasion strip. Such methods can also include positioning the heating element at least partially between the rotor blade and the second portion of the abrasion strip (e.g., such as between the bottom surface 220 and abrasion strip 244, as depicted in FIG. 6), moving the mounting member such that the heating element moves between the rotor blade and the second portion of the abrasion strip, and disengaging the rotor blade from the second portion of the abrasion strip. In some embodiments, the component to be removed can be disengaged once or more than once to better enable removal of the component. Some of the methods include, prior to positioning the heating element at least partially between the rotor blade and the second portion of the abrasion strip, uncoupling the heating element from the mounting member (e.g., such as from first end 324 of second arm 320) and coupling the heating element to the mounting member in a different configuration (e.g., such as in between first end 324 and second end 328 of second arm 320) to, for example, enable the heating element to be positioned in contact with a plurality of portions of a rotor blade (e.g., both top surface 216 and bottom surface 220 of rotor blade 200) such that at least some of the heating element substantially conforms to each portion of the rotor blade. Some of the methods include, positioning the heating element in a recess adjacent to the abrasion strip 244 to assist locating the edge where the abrasion strip 244 is located on the top surface 216 and bottom surface 220 of the rotor blade.

In some embodiments, when the two components to be disengaged are a rotor blade and an abrasion strip, the methods do not require separating the abrasion strip, and the methods include positioning the heating element at least partially between the rotor blade and the abrasion strip (e.g., between top surface 216 and bottom surface 220 and abrasion strip 244, for example, simultaneously), moving the mounting member such that the heating element slidably moves between the rotor blade and the abrasion strip, and disengaging the rotor blade from the abrasion strip.

The tools and methods that are detailed herein provide numerous advantages to disengage and/or remove one component from another component. For example, with regard to aircrafts, and, more specifically, rotor blades, the tools and methods enable safe removal of components from the rotor blade, such as abrasion strips and erosion shields, because such tools and methods decrease or eliminate manual hammering to remove abrasion strips and erosion shields, which can result in operator inaccuracy and fatigue and related injuries. For the same reason, such tools and methods configured in accordance with the above disclosure can further decrease or eliminate noise associated with hammering, decrease or eliminate delamination and/or separation of rotor blade components (e.g., spar plies), which can result from inaccurate or improper striking of the rotor blade, and decrease or eliminate skin to core voids, which can result from inaccurate or improper striking of the rotor blade. In this way, the disclosed tools and methods can increase the life of rotor blades and can prevent or eliminate costs associated with damaged rotor blades due to improper component removal.

The terms “a” and “an” are defined as one or more unless this disclosure explicitly requires otherwise.

The term “substantially” is defined as largely, but not necessarily wholly, what is specified (and includes what is specified; e.g., substantially 90 degrees includes 90 degrees), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The term “generally” is defined as having an overall geometric shape that resembles the specified shape with slight deviations.

Terms such as “first” and “second” are used only to differentiate features and not to limit the different features to a particular order or to a particular quantity.

Where numerical ranges or limitations are expressly stated, such express ranges or limitations should be understood to include iterative ranges or limitations of like magnitude falling within the expressly stated ranges or limitations (e.g., from about 1 to about 10 includes 2, 3, 4, etc.; greater than 0.10 includes 0.11, 0.12, 0.13, etc.). For example, whenever a numerical range with a lower limit, Rₗ, and an upper, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Any numerical range defined by two R numbers as defined in the above is also specifically disclosed and includes the two R numbers.

Use of the term “optionally” with respect to any element of a claim means that the element is required, or alternatively, the element is not required, both alternatives being within the scope of the claim.

Use of broader terms such as comprises, includes, and has (and any derivatives of such terms, such as comprising, including, and having) should be understood to provide support for narrower terms, such as consisting of, consisting essentially of, and comprised substantially of. Thus, in any of the claims, the term “consisting of,” “consisting essentially of,” or “comprised substantially of” can be substituted for any of the open-ended linking verbs recited above in order to change the scope of a given claim from what it would otherwise be using the open-ended linking verb.

The same or similar features of one or more embodiments are sometimes referred to with the same reference numerals within a figure or among figures. However, one or more features having the same reference numeral should not be construed to indicate that any feature is limited to the characteristics of another feature having the same reference numeral, or that any feature cannot already have, or cannot be modified to have, features that are different from another feature having the same reference numeral.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. The feature or features of one embodiment may be applied to other embodiments to achieve still other embodiments, even though not described, unless expressly prohibited by this disclosure or the nature of the embodiments. The scope of protection is not limited by the description set out above but is defined by the claims that follow, the scope including all equivalents of the subject matter of the claims. Each and every claim is incorporated as further disclosure into the specification and the claims are embodiment(s) of the present invention.

The claims are not intended to include, and should not be interpreted to include, means-plus- or step-plus-function limitations, unless such a limitation is explicitly recited in a given claim using the phrase(s) “means for” or “step for,” respectively.

1. A tool for removing a portion of a rotor blade comprising:
a bracket;
a mounting member configured to be slidably coupled to the bracket; and
a heating element configured to be coupled to the mounting member, the heating element configured to heat and slide underneath the portion of a rotor blade to be removed.

2. The tool of claim 1, wherein the heating element is configured to be coupled to the mounting member such that, when the heating element contacts the rotor blade, at least some of the heating element substantially conforms to the rotor blade.

3. The tool of claim 1, wherein the heating element is configured to be heated to at least 180 degrees Fahrenheit by an electric current.

4. The tool of claim 1, wherein the portion of the rotor blade to be removed comprises an abrasion strip, and the heating element is configured to be heated to a temperature that is less than a melting point of a blade skin resin.

5. The tool of claim 1, wherein the portion of the rotor blade to be removed comprises an abrasion strip configured to be coupled to the rotor blade by an adhesive, and the heating element is configured to be heated to a temperature that is approximately equal to a melting point of the adhesive.

6. The tool of claim 1, wherein the mounting member comprises a first arm and a second arm, the first and second arms are fixedly connected at one end and the heating element is coupled to the opposing ends of the first and second arms.

7. A tool for removing a portion of a rotor blade comprising:
a bracket configured to be positioned adjacent to a rotor blade;
a mounting member slidably coupled to the bracket; and
a heating element coupled to the mounting member, the heating element configured to heat and slide underneath the portion of the rotor blade to be removed;
wherein the mounting member slides on the bracket such that the heating element disengages the portion of the rotor blade to be removed from the rotor blade.

8. The tool of claim 7, wherein the bracket comprises a plurality of bars that are positioned about parallel to the leading edge of the rotor blade.

9. The tool of claim 8, wherein the mounting member comprises a first arm coupled to a second arm at an angle, the first arm and the second arm each including an opening for receiving a bar therethrough.

10. The tool of claim 9, wherein the heating element is coupled at one end to the first arm and the opposing end to the second arm such that at least some of the heating element conforms to the portion of the rotor blade to be removed.

11. The tool of claim 7, wherein the mounting member is generally curvilinear in shape.

12. The tool of claim 7, wherein at least one of the heating element, the mounting member, and the bracket are configured to bias the heating element toward the portion of the rotor blade to be removed.

13. The tool of claim 9, further comprising a biasing element associated with the heating element and at least one of the first arm and the second arm, the biasing element configured to bias the heating element toward the portion of the rotor blade to be removed.

14. A method for removing a portion of a rotor blade comprising:
positioning a tool adjacent to a rotor blade with a portion of the rotor blade to be removed, where the tool comprises:
a bracket;
a mounting member slidably coupled to the bracket; and
a heating element coupled to the mounting member;
heating at least some of the portion of the rotor blade to be removed with the heating element;
slidably moving the mounting member such that the heating element moves between the rotor blade and the portion of the rotor blade to be removed; and
disengaging the portion of the rotor blade to be removed from the rotor blade.

15. The method of claim 14, wherein the step of positioning further includes positioning the heating element in a recess adjacent to the portion of the rotor blade to be removed.

16. The method of claim 14, further comprising coupling the heating element to the mounting member in a tension configuration.

17. The method of claim 14, wherein the heating element is an electrically conductive wire.

18. The method of claim 14, wherein the portion of the rotor blade to be removed comprises an abrasion strip.

19. The method of claim 18, wherein the heating step comprises heating an adhesive that secures the abrasion strip to the rotor blade to a temperature that melts a portion of the adhesive.

20. The method of claim 14, wherein the heating step comprises passing an electric current through the heating element.

21. The method of claim 14, wherein the slidably moving step comprises moving the mounting member substantially parallel to the leading edge of the rotor blade.
